(19) United States
(12) Patent Application Publication
(10) Pub. No.: US 2009/0184887 A1
(43) Pub. Date: Jul. 23, 2009

(54) DISPLAY APPARATUS HAVING A PLURALITY OF DISPLAYS AND CONTROL METHOD THEREFOR

(75) Inventors: Shogo Mizuno, Kawasaki-shi (JP); Tetsu Fukuda, Yokohama-shi (JP); Tomoyasu Yoshikawa, Kawasaki-shi (JP); Yuji Tanaka, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/353,439

(22) Filed: Jan. 14, 2009

(30) Foreign Application Priority Data
Jan. 18, 2008 (JP) 2008-009174

(51) Int. Cl. G09G 5/00

(52) U.S. Cl. 345/1.1

(57) ABSTRACT

A display apparatus includes a main display control unit to control display characteristic parameters of a main display and a sub-display control unit to control display characteristic parameters of a sub-display. A determination unit determines whether to highlight data according to contents of the data to be displayed on the sub-display. When it is determined that the data is highlighted, the sub-display control unit controls the display characteristic parameter of the sub-display in a manner not interlocking with the display characteristic parameter of the main display. On the other hand, when it is not determined that the data is highlighted, the sub-display control unit controls the display characteristic parameter of the sub-display in a manner interlocking with the display characteristic parameter of the main display.

### BACKGROUND OF THE INVENTION

1. Field of the Invention

The present invention relates to a display apparatus having a plurality of displays and a method for controlling the display apparatus.

2. Description of the Related Art

When using a conventional display apparatus having a plurality of displays, a user can individually or simultaneously adjust display characteristic parameters of each display, such as luminance and contrast. Japanese Patent Application Laid-Open No. 2005-031597 discusses a method for controlling the contrast of two or more kinds of displays which have different contrast control systems to be at an equivalent level.

In an image display apparatus in Japanese Patent Application Laid-Open No. 2005-031597, the contrasts of a plurality of displays are interlockingly controlled so that they are always at the equivalent level. However, it is not necessarily desirable to control the contrasts at the equivalent level by interlocking display characteristic parameters of the plurality of displays all the time.

For example, in a case where a caption of a broadcast program is displayed on a sub-display while a video image of the broadcast program is displayed on a main display, it may be desirable to control the display characteristic parameters on both of the main display and the sub-display to be at the equivalent level. However, when important information to be notified to the user is displayed on the sub-display, it is desirable to highlight the information on the sub-display to enable the user to notice the information.

### SUMMARY OF THE INVENTION

The present invention is directed to a display apparatus and its control method capable of suitably controlling display characteristic parameters of a sub-display (second display area) by interlocking with or not interlocking with display characteristic parameters of a main display (first display area).

According to an aspect of the present invention, a display apparatus having a first display area and a second display area includes a setting unit configured to set a display characteristic parameter of the first display area, a first display control unit configured to control display of the first display area by using the display characteristic parameter set by the setting unit, a determination unit configured to determine whether to interlock a display characteristic parameter of the second display area with the display characteristic parameter of the first display area according to contents of data displayed on the second display area, and a second display control unit configured to control display of the second display area by setting the display characteristic parameter of the second display area at a value corresponding to the display characteristic parameter of the first display area when the determination unit determines to interlock the display characteristic parameter of the second display area with the display characteristic parameter of the first display area, and by setting the display characteristic parameter of the second display area at a value which can raise a user's recognition level higher when the determination unit determines not to interlock the display characteristic parameter of the second display area with the display characteristic parameter of the first display area than a level when data is displayed with the display characteristic parameter of the first display area.

According to another aspect of the present invention, a display apparatus having a first display area and a second display area, includes a setting unit configured to set a display characteristic parameter of the first display area, a first display control unit configured to control display of the first display area by using the display characteristic parameter set by the setting unit, an operation unit configured to operate the display apparatus according to an instruction from a user, a determination unit configured to determine whether to interlock a display characteristic parameter of the second display area with the display characteristic parameter of the first display area according to contents of an operation by the operation unit, and a second display control unit configured to control display of the second display area by setting the display characteristic parameter of the second display area at a value corresponding to the display characteristic parameter of the first display area when the determination unit determines to interlock the display characteristic parameter of the second display area with the display characteristic parameter of the first display area, and by setting the display characteristic parameter of the second display area at a value which can raise a user's recognition level higher when the determination unit determines not to interlock the display characteristic parameter of the second display area with the display characteristic parameter of the first display area than a level when data is displayed with the display characteristic parameter of the first display area.

According to exemplary embodiments of the present invention, the display characteristic parameters of the sub-display (second display area) can be controlled suitably by interlocking with or not interlocking with the display characteristic parameters of the main display (first display area).

Further features of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram illustrating a configuration of a display apparatus according to a first exemplary embodiment of the present invention.

FIG. 2 is a table illustrating an example of determination conditions used in the determination unit illustrated in FIG. 1.

FIG. 3 is a flowchart illustrating operations of the sub-display control unit illustrated in FIG. 1.

FIG. 4 is an example of a screen display when a luminance level of the sub-display is set to a predetermined value P1.

FIG. 5 is an example of a screen display when the luminance level of the sub-display is set at a level which is interlocked with the main display.

FIG. 6 is a block diagram illustrating a configuration of the display apparatus according to a second exemplary embodiment of the present invention.

FIG. 7 is a table illustrating an example of determination conditions used in the determination unit illustrated in FIG. 6.

FIG. 8 is an example of a user interface (UI) screen which a user can operate on the sub-display.

FIG. 9 is an example of a screen display after an image on the main display is switched from a state illustrated in FIG. 8 when a desired channel is selected.

### DETAILED DESCRIPTION OF THE EMBODIMENTS

Embodiments of the invention will be described in detail below with reference to the drawings.

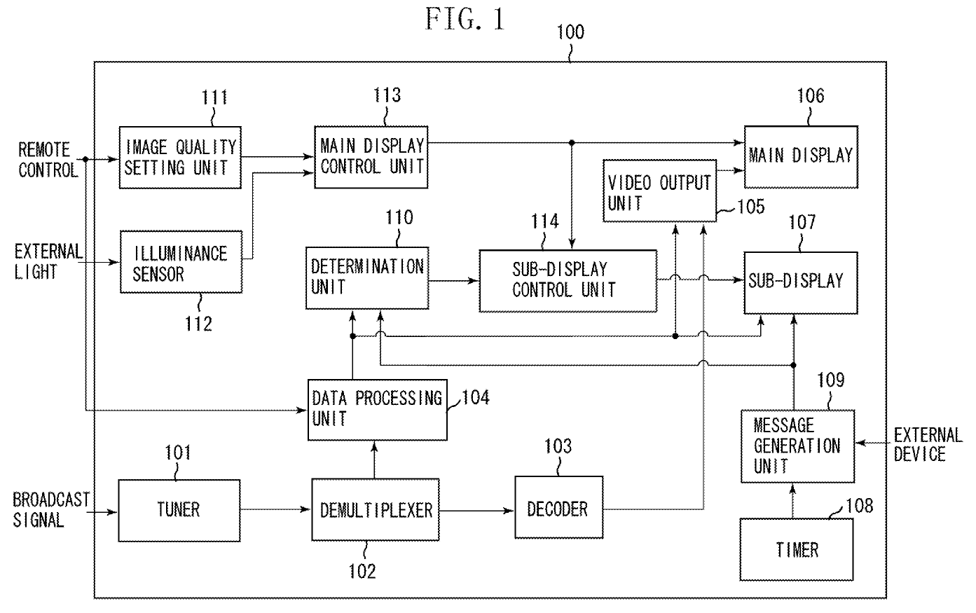

FIG. 1 is a block diagram illustrating a configuration of a display apparatus 100 according to a first exemplary embodiment of the present invention. The display apparatus 100 has a plurality of displays. In the first exemplary embodiment, a TV receiver with a built-in tuner 101 to receive digital broadcasting is described as an example of the present invention, but the present invention can be applied to any display apparatus including a plurality of displays.

The display apparatus 100 includes the tuner 101, a demultiplexer 102, a decoder 103, a data processing unit 104, a video output unit 105, a main display (first display area) 106, a sub-display (second display area) 107, a timer 108, a message generation unit 109, a determination unit 110, an image quality setting unit 111, an illuminance sensor 112, a main display control unit 113, and a sub-display control unit 114.

The tuner 101 receives a digital broadcast signal, and generates data in a transport stream (TS) format. The demultiplexer 102 separates the transport stream from the tuner 101 into a video signal, an audio signal, and a data signal. The decoder 103 decodes the video signal and the audio signal transmitted from the demultiplexer 102.

The data processing unit 104 decodes the data signal transmitted from the demultiplexer 102 and generates an image signal to be output to the main display 106 and the sub-display 107. When a user sends an instruction to display an electronic program guide (EPG) and display data broadcast from a remote controller, the data processing unit 104 decodes the EPG data and data for data broadcast, generates an image signal for forming a user-interface (UI) screen, and outputs the image signal to the video output unit 105. When the user sends an instruction to display a caption and program information from the remote controller, the data processing unit 104 decodes caption information, program attribute information (a channel number, a program title, program detail information, etc.), and outputs necessary information to the determination unit 110 or the sub-display 107. Further, when emergency alert information which is superposed on a broadcast signal is received, the data processing unit 104 decodes the emergency alert information and outputs decoded information to the determination unit 110 and the sub-display 107.

The video output unit 105 outputs a video image decoded by the decoder 103 to the main display 106. The video output unit 105 outputs the EPG data and the data for data broadcast decoded by the data processing unit 104 to the main display 106. It is previously set whether the main display 106 or the sub-display 107 displays each kind of information output from the data processing unit 104, but the user can arbitrarily change the setting. The audio signal decoded by the decoder 103 is output from a speaker via an audio output unit (not illustrated).

The timer 108 outputs current time information to the message generation unit 109. The message generation unit 109 generates a message based on viewing reservation information set in the TV receiver, recording reservation information input from an external device (a recorder, for example), and the current time information input from the timer 108. If an error occurs in the TV receiver and an error signal is received from the external device, the message generation unit 109 generates an error message. Various messages that are generated by the message generation unit 109 are displayed on the sub-display 107.

The determination unit 110, based on preset determination conditions, determines whether to highlight various items of information, such as the caption information, the program attribute information (a channel number, a program title, program detail information), and the emergency alert information decoded by the data processing unit 104, and messages generated by the message generation unit 109.

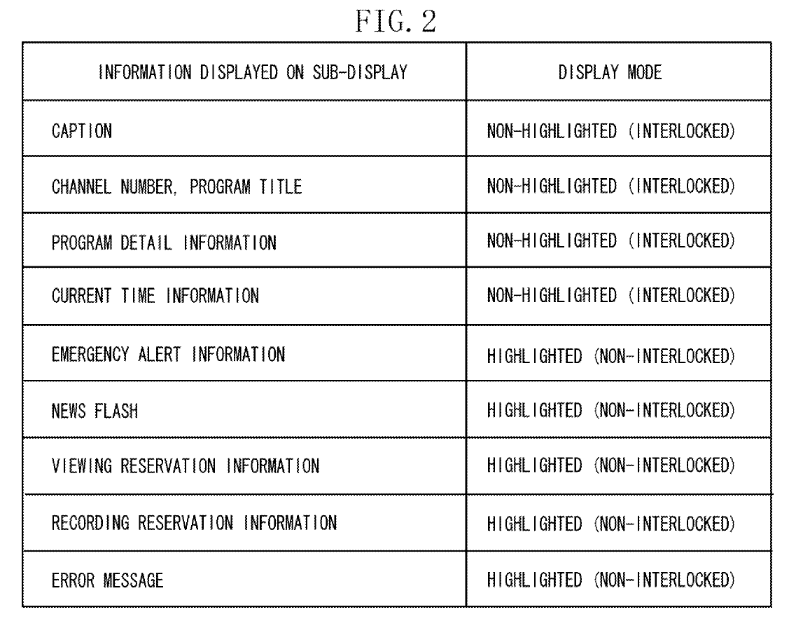

FIG. 2 is a table illustrating an example of the determination conditions used in the determination unit 110. The determination unit determines that, for example, the caption information, the channel number, the program title, the program detail information, and the current time information are the information not to be highlighted (non-highlighted display mode). On the other hand, the emergency alert information, a news flash, the viewing reservation information, the recording reservation information, and the error message are determined as information to be highlighted (highlighted display mode). However, setting of the determination conditions can be arbitrarily changed. Determination results by the determination unit 110 are output to the sub-display control unit 114.

Returning to FIG. 1, in response to the user's remote control operation, the image quality setting unit 111 sets an image quality mode (movie mode, dynamic mode, or standard mode) and display characteristic parameters, such as luminance, contrast, color temperature, color shade, and color density of the main display 106. Further, the image quality setting unit 111 has a function to automatically set the image quality mode corresponding to a genre of a program displayed on the main display 106.

The illuminance sensor 112 is an external light sensor to detect the illuminance of light coming from outside, for example. The main display control unit 113 controls various kinds of the display characteristic parameters of the main display 106 according to values set by the image quality setting unit 111. The main display control unit 113 controls a luminance level of the main display 106 based on illuminance information of external light detected by the illuminance sensor 112, and adjusts the luminance to a level suitable for the audio-visual environment (500 cd/m²). The display characteristic parameters set to the main display 106 and information about whether the main display 106 is displaying an image are supplied from the main display control unit 113 to the sub-display control unit 114.

The sub-display control unit 114, based on the determination results by the determination unit 110, controls various display characteristic parameters of the sub-display 107, such as the luminance, the contrast, the color temperature, the color shade, and the color density.

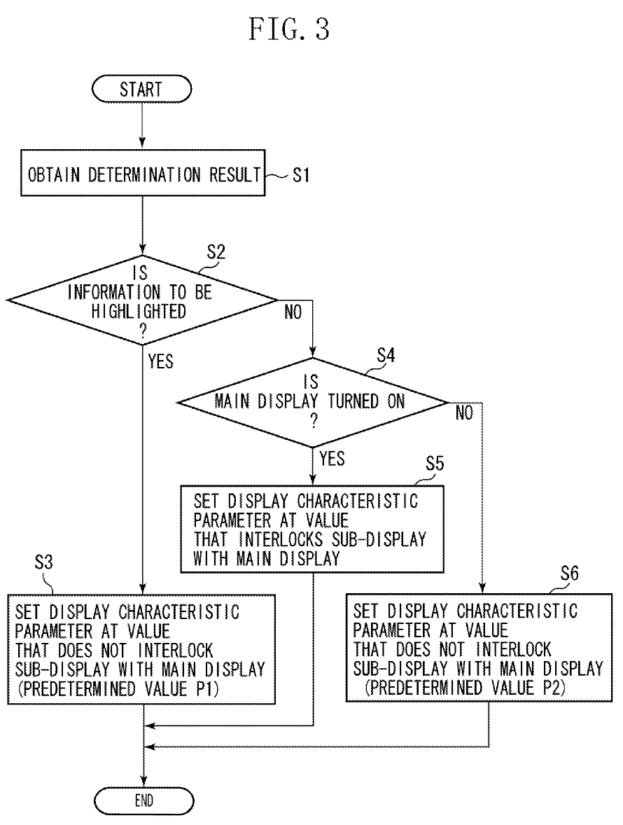

FIG. 3 is a flowchart illustrating operations of the sub-display control unit 114. In step S1, the sub-display control unit 114 obtains the determination results from the determination unit 110. Next, in step S2, the sub-display control unit 114 determines whether the determination unit 110 has determined that information which is displayed on the sub-display 107 is to be highlighted. If it has been determined that the information is to be highlighted (in the highlighted display mode) (YES in step S2), the process proceeds to step S3. If it has been determined that the information is not to be highlighted (in the non-highlighted display mode) (NO in step S2), the process proceeds to step S4.

In step S3, the sub-display control unit 114 sets various display characteristic parameters of the sub-display 107, such as luminance, contrast, color temperature, color shade, and color density, at values (a predetermined value P1, for example) which are not interlocked with the main display 106. In this case, the information which is displayed on the sub-display 107 is highlighted to raise the user's recognition level.

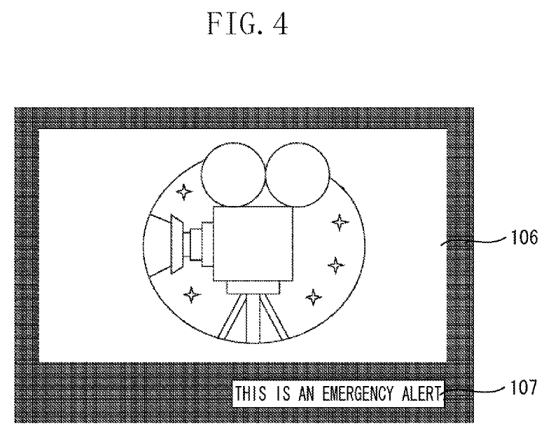

FIG. 4 is an example of a screen display when the luminance level of the sub-display 107 is set to the predetermined value P1 (600 cd/m², for example). In FIG. 4, the sub-display 107 displays a message “This is an emergency alert.” Since the emergency alert information is to be highlighted, to enable the user to recognize the message easily, the luminance level of the sub-display 107 is set at a higher value than the luminance level of the main display 101. However, it may be configured to control not only the luminance level but also other display characteristic parameters, such as the contrast, the color temperature, the color shade, and the color density.

In step S4, the sub-display control unit 114 determines whether the main display 106 displays an image based on an output signal from the main display control unit 113 (in other words, whether the main display 106 is ON). If it is determined that the main display 106 is ON (YES in step S4), the process proceeds to step S5. If it is determined that the main display 106 is OFF (NO in step S4), the process proceeds to step S6.

In step S5, the sub-display control unit 114 sets the various display characteristic parameters of the sub-display 107, such as the luminance, the contrast, the color temperature, the color shade, and the color density, at values which are interlocked with the main display 106. For example, if the main display 106 displays an image with an image quality in the movie mode, the sub-display 107 is also operated with the display characteristic parameters interlocked with the movie mode. Meanwhile, if the main display 106 and the sub-display 107 have the same display characteristics, the sub-display control unit 114 sets the same display characteristic parameters as those of the main display 106 to the sub-display 107. If the main display 106 and the sub-display 107 have different display characteristics, the sub-display control unit 114 sets to the sub-display 107 the display characteristic parameters which are equivalent to (corresponding to) those of the main display 106.

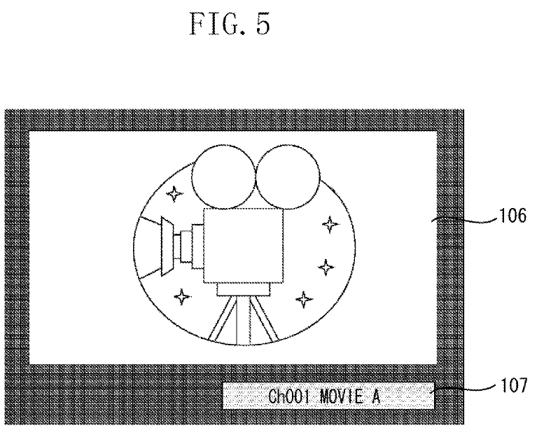

FIG. 5 is an example of a screen display when the luminance level of the sub-display 107 is set at a level which is interlocked with the main display 106 (500 cd/m², for example) In FIG. 5, the sub-display 107 displays the channel number and the program title of “CH001 Movie A”. Since the channel number and the title of the program are not to be highlighted, the luminance level is set at the level which is interlocked with the main display 106 and does not interfere with viewing of the main display 106.

In step S6, the sub-display control unit 114 sets the various display characteristic parameters of the sub-display 107, such a the luminance, the contrast, the color temperature, the color shade, and the color density, at values which are not interlocked with the main display 106 (a predetermined value P2, for example). In this case, because the main display 106 does not display an image, the display characteristic parameters of the sub-display 107 are set at preset standard values (a luminance of 300 cd/m², for example). Information displayed on the sub-display 107 in this case is the current time information, for example.

In step S3, after a predetermined time elapses from highlighting the information displayed on the sub-display 107, display on the sub-display 107 may be controlled to interlock with the main display 106. Further, together with the highlighted information on the sub-display 107, sound may be output from a speaker to enable the user to easily recognize the information.

As described above, in the first exemplary embodiment, the display characteristic parameters of the sub-display 107 can be suitably controlled by interlocking or not interlocking with the display characteristic parameters of the main display 106 depending on information displayed on the sub-display 107.

In the first exemplary embodiment, a case is described where the sub-display control unit 114 receives the display characteristic parameters of the main display 106 from the main display control unit 113, but the present invention is not limited to the first exemplary embodiment. For example, the sub-display control unit 114 may receive information about the image quality mode (movie mode, dynamic mode or standard mode) set by the image quality setting unit 111 and illuminance information about external light detected by the illuminance sensor 112. In this case, the sub-display control unit 114 can perform display control independent from the main display control unit 113 based on the image quality information set by the image quality setting unit 111 and the illuminance information from the illuminance sensor 112.

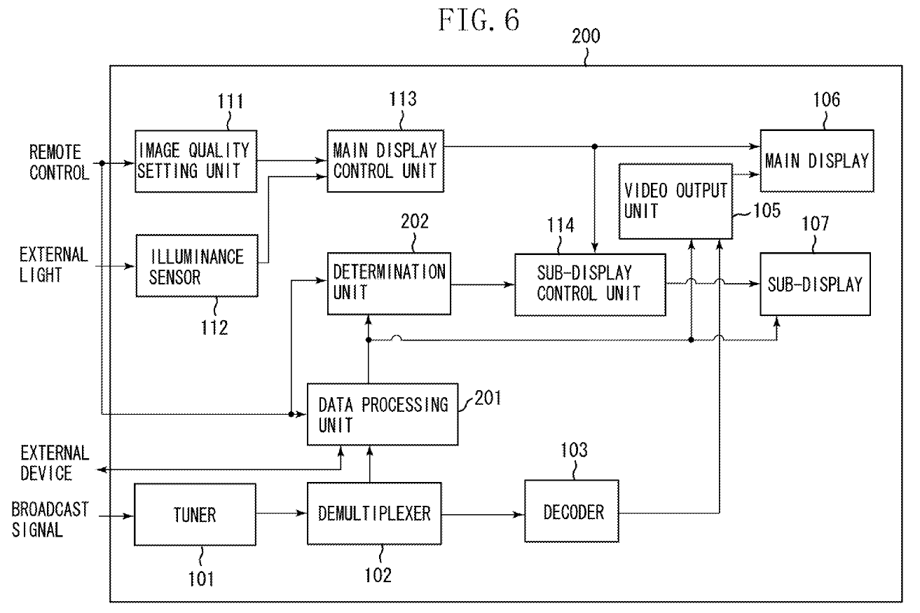

FIG. 6 is a block diagram illustrating a configuration of a display apparatus 200 according to a second exemplary embodiment of the preset invention. In FIG. 6, same numerals are used to designate blocks which have similar functions as in the display apparatus 100 in FIG. 1, and their descriptions are not repeated.

A data processing unit 201, as described in the first exemplary embodiment, decodes a data signal received from the demultiplexer 102 and generates an image signal to be output to the main display 106 and the sub-display 107. The data processing unit 201 has a function to generate the image signal for forming a UI screen that can be operated by the user on the sub-display 107.

A determination unit 202 receives an output signal from the data processing unit 104 and a key input signal from the remote controller, and determines whether to set the sub-display 107 in the highlighted display mode based on the preset determination conditions.

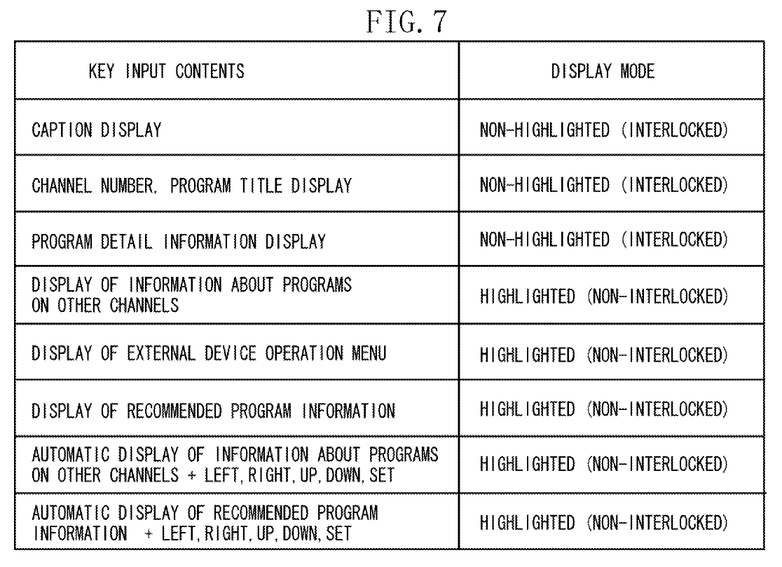

FIG. 7 is a table illustrating an example of the determination conditions used in the determination unit 202. When the user sends an instruction to display the caption, the channel number and the program title, and the program detail information from the remote controller, the data processing unit 201 causes the sub-display 107 to display the information. Further, when an instruction to display information about programs on other channels, an external device operation menu, and recommended programs is received from the user by an operation of the remote controller, the data processing unit 201 causes the sub-display 107 to display the requested information and forms the UI screen that can be operated by the user on the sub-display 107.

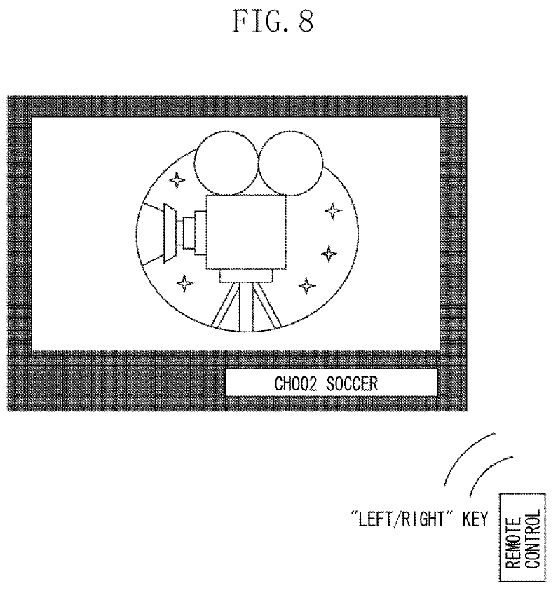

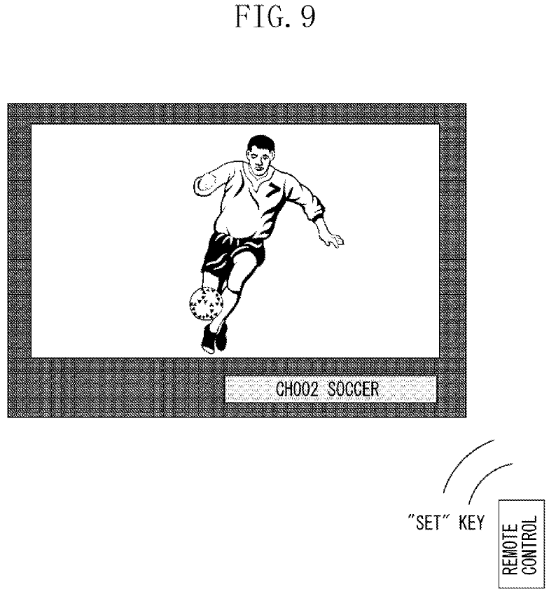

FIG. 8 is an example of the UI screen that can be operated by the user on the sub-display 107. When the information about programs on other channels (programs currently running on other channels) is displayed on the sub-display 107, the user can switch over the program to other channels one after another by using left/right keys (or up/down keys) of the remote controller. When the user presses a “set” key on the remote controller, the channel of the program “CH002 Soccer” currently displayed on the sub-display 107 is selected and the image on the main display 106 is changed. FIG. 9 is an example of the screen display after the image on the main display 106 was changed from the state shown in FIG. 8 by selecting the channel.

When an external device operation menu for designating a function of a connected recorder such as start recording, stop recording, and display an operation function list, is displayed on the sub-display 107, the user can operate the external devices with the left/right keys (or the up/down key) on the remote controller. However, when the display apparatus 200 has a built-in recorder function, an operation menu of the built-in recorder may be displayed.

Further, the data processing unit 201 has a function to search for recommending programs based on information about user's preference and display a selected program on the sub-display 107. When the recommended program information is displayed on the sub-display 107, the user can sequentially switch among information about a plurality of recommending programs with the left/right keys (or the up/down keys) on the remote controller. When the user presses the set key on the remote controller, it becomes possible to set a viewing reservation or a recording reservation of the recommending program.

When an instruction to display the caption, the channel number, the program title, and the program detail information is received from the remote controller operated by the user, the determination unit 202 determines that any of those items of information is not to be highlighted (namely, in the non-highlighted display mode). On the other hand, when an instruction to display the information about programs on other channels, the external device operation menu, and the recommending program information is received, the determination unit 202 determines that those items of information are to be highlighted (in the highlighted display mode). The instructions to display the information about programs on other channels, the external device operation menu, and the recommending program information are issued with respect to the sub-display 107, and are not directly concerned with the image displayed on the main display 106. In such cases, because the user is more likely to give priority to display on the sub-display 107, the above-described determination conditions are provided.

In a case where the information about programs on other channels and the information about recommending programs are automatically displayed at predetermined timing on the sub-display 107, when any one of the left, right, up, down, and the set keys on the remote controller is pressed under a condition that one of above mentioned programs is displayed, it is determined that the information is displayed in the highlighted display mode. In a stage where the information about programs on other channels or recommended programs is automatically displayed on the sub-display 107, it is not clear whether the user prefers to prioritize the display on the sub-display. Accordingly, the information is displayed in the non-highlighted manner. When the user presses one of the left, right, up, down, and set keys on the remote controller, it is understood that the user feels interest in the information about programs on other channels and the recommended programs shown on the sub-display 107, so that the current mode changes to the highlighted display mode.

The determination conditions can be changed arbitrarily, and are not limited to the items shown in FIG. 7. Determination results by the determination unit 110 are output to the sub-display control unit 114. Operation of the display control unit 114 in FIG. 6 is not described since it is similar to that illustrated in FIG. 3.

For example, as shown in FIG. 8, when the user instructs to display the information about programs on other channels, it is determined that information is to be highlighted (in the highlighted display mode), and the information on the sub-display 107 is highlighted to raise the user's recognition. At this time, the various display characteristic parameters of the sub-display 107, such as the luminance, the contrast, the color temperature, the color shade, and the color density, are set at values (for example, a predetermined value P1: luminance of 600 cd/m²) which are not interlocked with the main display 106. When the UI screen that can be operated by the user is displayed on the sub-display 107, highlighting of contents enables the user to easily recognize the displayed contents on the sub-display 107.

As shown in FIG. 9, when the user presses the set key on the remote controller to select the channel for the program “CH002 Soccer” on the sub-display 107, the information on the sub-display 107 is not highlighted. At this time, the various display characteristic parameters, such as the luminance, the contrast, the color temperature, the color shade, and the color density of the sub-display 107, are set at values (for example, a luminance of 500 cd/m²) which are interlocked with the main display 106. Since the channel number and the program title are not the information to be highlighted, those items are set as display characteristic parameters interlocked with the main display 106 so that they do not interfere with viewing of the main display 106.

As described above, in the second exemplary embodiment, the display characteristic parameters of the sub-display 107 can be controlled suitably by interlocking or not interlocking with the display characteristic parameters of the main display 106 according to contents of the remote control operation by the user.

The processing described in the above embodiments can be realized by providing a storage medium storing program code of software realizing the above-described functions, to a computer system or apparatus. By reading the program code stored in the storage medium with a computer (or a central processing unit (CPU) or a micro processing unit (MPU)) of the system or apparatus and executing them, the functions of the above-described embodiments can be realized. In this case, the program code read from the storage medium realizes the functions according to the exemplary embodiments, and the storage medium storing the program code constitutes the present invention. The storage medium, such as a floppy disk, a hard disk, an optical disk, a magneto-optical disk and the like can be used for providing the program code. Also, a compact disc read-only memory (CD-ROM), a CD-recordable (CD-R), a magnetic tape, a non-volatile memory card, ROM, and the like can be used.

Furthermore, the functions according to the above exemplary embodiments are realized not only by executing the program code read by the computer. The present invention also includes a case where an operating system (OS) or the like working on the computer performs part or the entire processes in accordance with designations of the program codes and realizes the functions according to the above exemplary embodiments.

Furthermore, the program code read from the storage medium can be written in a function expansion card which is inserted into the computer or in a memory provided in a function expansion unit which is connected to the computer. Thereafter, a CPU or the like contained in the function expansion card or unit can perform part or the entire processes in accordance with designations of the program code and can realize the functions of the above embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2008-009174 filed Jan. 18, 2008, which is hereby incorporated by reference herein in its entirety.

What is claimed is:

1. A display apparatus having a first display area and a second display area, comprising:
a setting unit configured to set a display characteristic parameter of the first display area;
a first display control unit configured to control display of the first display area by using the display characteristic parameter set by the setting unit;
a determination unit configured to determine whether to interlock a display characteristic parameter of the second display area with the display characteristic parameter of the first display area according to contents of data displayed on the second display area; and
a second display control unit configured to control display of the second display area by setting the display characteristic parameter of the second display area at a value corresponding to the display characteristic parameter of the first display area when the determination unit determines to interlock the display characteristic parameter of the second display area with the display characteristic parameter of the first display area, and by setting the display characteristic parameter of the second display area at a value which can raise a user's recognition level higher when the determination unit determines not to interlock the display characteristic parameter of the second display area with the display characteristic parameter of the first display area than a level when data is displayed with the display characteristic parameter of the first display area.

2. The display apparatus according to claim 1, wherein the second display control unit sets the display characteristic parameter of the second display area at a predetermined value when the determination unit determines not to interlock the display characteristic parameter of the second display area with the display characteristic parameter of the first display area.

3. The display apparatus according to claim 1, wherein the second display control unit sets the display characteristic parameter of the second display area at a predetermined value when the first display area is not displaying an image and the determination unit determines to interlock the display characteristic parameter of the second display area with the display characteristic parameter of the first display area.

4. The display apparatus according to claim 1, wherein the first and second display control units perform display control by using at least one of the display characteristic parameters among luminance, contrast, color temperature, color shade and color density.

5. The display apparatus according to claim 1, wherein the determination unit determines not to interlock the display characteristic parameter of the second display area with the display characteristic parameter of the first display area when data to be displayed on the second display area is one of emergency alert information, news flash, viewing reservation information, recording reservation information, and an error message.

6. A display apparatus having a first display area and a second display area, comprising:
a setting unit configured to set a display characteristic parameter of the first display area;
a first display control unit configured to control display of the first display area by using the display characteristic parameter set by the setting unit;
an operation unit configured to operate the display apparatus according to an instruction from a user;
a determination unit configured to determine whether to interlock a display characteristic parameter of the second display area with the display characteristic parameter of the first display area according to contents of an operation by the operation unit; and
a second display control unit configured to control display of the second display area by setting the display characteristic parameter of the second display area at a value corresponding to the display characteristic parameter of the first display area when the determination unit determines to interlock the display characteristic parameter of the second display area with the display characteristic parameter of the first display area, and by setting the display characteristic parameter of the second display area at a value which can raise a user's recognition level higher when the determination unit determines not to interlock the display characteristic parameter of the second display area with the display characteristic parameter of the first display area than a level when data is displayed with the display characteristic parameter of the first display area.

7. The display apparatus according to claim 6, wherein the determination unit determines not to interlock the display characteristic parameter of the second display area with the display characteristic parameter of the first display area when the operation by the operation unit is directed to the second display area and is not directly related to data which is displayed on the first display area.

8. A method for controlling a display apparatus having a first and a second display area, comprising:
setting a display characteristic parameter of the first display area;
controlling display of the first display area by using the set display characteristic parameter;
determining whether to interlock a display characteristic parameter of the second display area with the display characteristic parameter of the first display area according to contents of data displayed on the second display area; and
controlling display of the second display area by setting the display characteristic parameter of the second display area at a value corresponding to the display characteristic parameter of the first display area when the display characteristic parameter of the second display area is determined to be interlocked with the display characteristic parameter of the first display area, and setting the display characteristic parameter of the second display area at a value which can raise a user's recognition level higher when the display characteristic parameter of the second display area is determined not to be interlocked with the display characteristic parameter of the first display area than a level when data is displayed with the display characteristic parameter of the first display area.

9. The method according to claim 8, further comprising, when the display characteristic parameter of the second display area is determined not to be interlocked with the display characteristic parameter of the first display area, setting the display characteristic parameter of the second display area at a predetermined value.

10. The method according to claim 8, further comprising: when the display characteristic parameter of the second display area is determined to be interlocked with the display characteristic parameter of the first display area and the first display area is not displaying an image, setting the display characteristic parameter of the second display area at a predetermined value.

11. The method according to claim 8, further comprising: performing display control of the first display area and the second display area by using at least one of display characteristic parameters among luminance, contrast, color temperature, color shade, and color density.

12. The method according to claim 8, further comprising: when the data to be displayed on the second display area is one of emergency alert information, news flash, viewing reservation information, recording reservation information, and an error message, determining not to interlock the display characteristic parameter of the second display area with the display characteristic parameter of the first display area.

13. A method for controlling a display apparatus having a first and a second display area, comprising:
setting a display characteristic parameter of the first display area;
controlling display of the first display area by using the set display characteristic parameter;
operating the display apparatus according to an instruction from a user;
determining whether to interlock the display characteristic parameter of the second display area with the display characteristic parameter of the first display area according to contents of an operation to the display apparatus; and
controlling display of the second display area by setting the display characteristic parameter of the second display area at a value corresponding to the display characteristic parameter of the first display area when the display characteristic parameter of the second display area is determined to be interlocked with the display characteristic parameter of the first display area, and setting the display characteristic parameter of the second display area at a value which can raise a user's recognition level higher when the display characteristic parameter of the second display area is determined not to be interlocked with the display characteristic parameter of the first display area than a level when the data is displayed with the display characteristic parameter of the first display area.

14. The method according to claim 13, further comprising: when the operation is directed to the second display area and is not directly related to data which is displayed on the first display area, determining not to interlock the display characteristic parameter of the second display area with the display characteristic parameter of the first parameter.
